(19) United States
(12) Patent Application Publication
(10) Pub. No.: US 2006/0256285 A1
(43) Pub. Date: Nov. 16, 2006

(54) Method for machining an eyeglass lens, and adhesive label useful when machining the eyeglass lens

(76) Inventor: Chin-Hung Lin, Taitung City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/412,906

(22) Filed: Apr. 28, 2006

(30) Foreign Application Priority Data
May 12, 2005 (TW) 094115362

(51) Int. Cl. G02C 7/02

(52) U.S. Cl. 351/177

(57) ABSTRACT

A method for machining an eyeglass lens, which has marks at optical and curvature centers thereof, includes the step of attaching a transparent sheet, which is printed with a grid pattern having a grid center and a grid line that passes through the grid center, on the eyeglass lens such that the grid center is aligned with the mark at the optical center of the eyeglass lens and such that the grid line of the grid pattern passes through the mark at the curvature center of the eyeglass lens so as to facilitate accurate markings of machining positions on the eyeglass lens to be machined. An adhesive label, which includes the transparent sheet, and the grid pattern that is printed on the transparent sheet, is also disclosed.

### CROSS-REFERENCE TO RELATED APPLICATION

This application claims priority of Taiwanese application no. 094115362, filed on May 12, 2005.

### BACKGROUND OF THE INVENTION

1. Field of the Invention

This invention relates to a method for machining an eyeglass lens, more particularly to a method for machining an eyeglass lens that is provided with a grid pattern thereon.

2. Description of the Related Art

In European Patent No. 0876874A2, as well as in French Patent No. 2686537, there is disclosed a method for determining and marking optical and curvature centers of an eyeglass lens.

Referring to FIG. 1, after the eyeglass lens 9 is marked at the optical and curvature centers thereof by performing the method of the prior art, the eyeglass lens 9 is machined in a conventional method, which includes the steps of:
(A) marking the eyeglass lens 9 with a horizontal line (not shown) that passes through the mark (not shown) at the optical center thereof;
(B) marking the eyeglass lens 9, based on the horizontal line marked in step (A), at machining positions (not shown); and
(C) machining the eyeglass lens 9 at the machining positions marked in step (B) to result in the shape of and holes 91, 92 in the eyeglass lens 9.

The aforementioned conventional method is disadvantageous in that, since step (A) is performed manually, the process is prone to error, time consuming, inaccurate, and irreproducible.

### SUMMARY OF THE INVENTION

Therefore, the object of the present invention is to provide a method for machining an eyeglass lens that can overcome the aforesaid drawbacks of the prior art.

According to a first aspect of the present invention, a method for machining an eyeglass lens, which has marks at optical and curvature centers thereof, comprises the step of printing the eyeglass lens with a grid pattern having a grid center that is aligned with the mark at the optical center of the eyeglass lens, and a grid line that passes through the grid center and the mark at the curvature center of the eyeglass lens so as to facilitate accurate markings of machining positions on the eyeglass lens to be machined.

According to a second aspect of the present invention, a method for machining an eyeglass lens, which has marks at optical and curvature centers thereof, comprises the step of attaching a transparent sheet, which is printed with a grid pattern having a grid center and a grid line that passes through the grid center, on the eyeglass lens such that the grid center is aligned with the mark at the optical center of the eyeglass lens and such that the grid line of the grid pattern passes through the mark at the curvature center of the eyeglass lens so as to facilitate accurate markings of machining positions on the eyeglass lens to be machined.

According to a third aspect of the present, a lens unit comprises an eyeglass lens and a grid pattern. The eyeglass lens has marks at optical and curvature centers thereof. The grid pattern is provided on the eyeglass lens, and has a grid center aligned with the mark at the optical center of the eyeglass lens, and a grid line passing through the grid center and the mark at the curvature center of the eyeglass lens.

According to a fourth aspect of the present invention, an adhesive label comprises a transparent sheet and a grid pattern. The transparent sheet is adapted to be attached adhesively to an eyeglass lens that has marks at optical and curvature centers thereof. The grid pattern is printed on the transparent sheet, and has a grid center that is adapted to be aligned with the mark at the optical center of the eyeglass lens, and a grid line that passes through the grid center and that is adapted to pass through the mark at the curvature center of the eyeglass lens.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of an eyeglass lens machined using a conventional method;

FIG. 2 is a schematic view of the first preferred embodiment of an adhesive label according to the present invention;

FIG. 3 is a sectional view of the first preferred embodiment;

FIG. 4 is a perspective view to illustrate erasable marks at optical and curvature centers of the eyeglass lens;

FIG. 5 to 12 are schematic views to illustrate different shapes and sizes of the first preferred embodiment;

FIG. 13 is a schematic view of the second preferred embodiment of an adhesive label according to the present invention;

FIG. 14 is a schematic view of the third preferred embodiment of an adhesive label according to the present invention;

FIG. 15 is a perspective view of the fourth preferred embodiment of an adhesive label according to the present invention;

FIG. 16 is a flowchart of the first preferred embodiment of a method for machining an eyeglass lens according to the present invention;

FIG. 17 is a sectional view to illustrate a state where a first release sheet of the adhesive label is peeled off;

FIG. 18 is a sectional view to illustrate a state where a transparent sheet of the adhesive label is attached adhesively to the eyeglass lens;

FIG. 19 is a perspective view of FIG. 18;

FIG. 20 is a flowchart of the second preferred embodiment of a method for machining an eyeglass lens according to the present invention; and

FIG. 21 is a perspective view to illustrate an erasable grid pattern printed on the eyeglass lens.

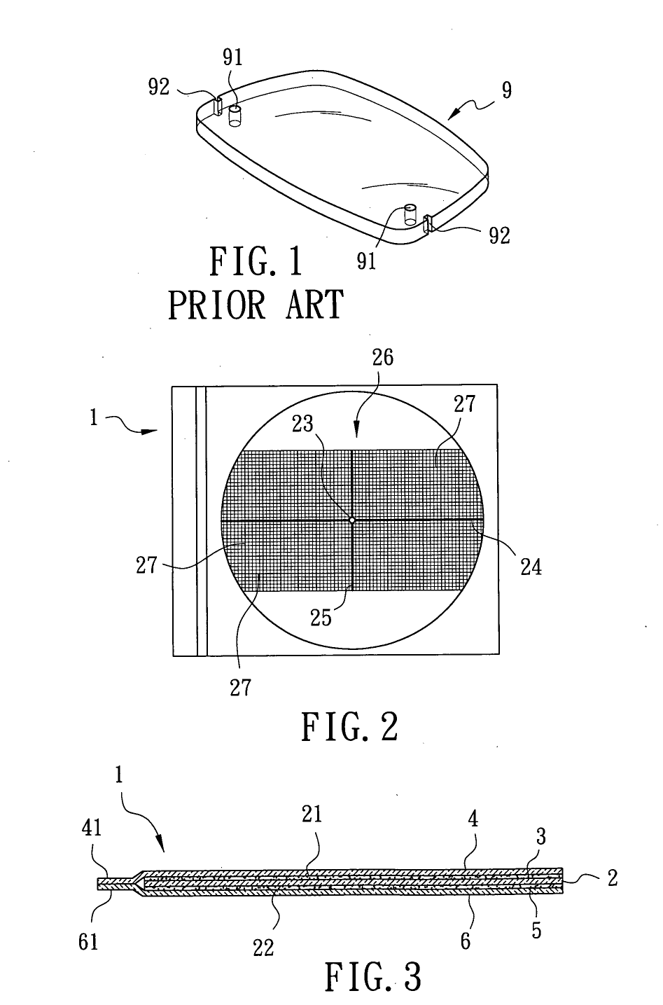

### DETAILED DESCRIPTION OF THE PREFERRED EMBODIMENTS

Before the present invention is described in greater detail, it should be noted that like elements are denoted by the same reference numerals throughout the disclosure.

Referring to FIGS. 2 and 3, the first preferred embodiment of an adhesive label 1 according to this invention is shown to include a transparent sheet 2, a grid pattern 26, first and second adhesive layers 3, 5, and first and second release sheets 4, 6.

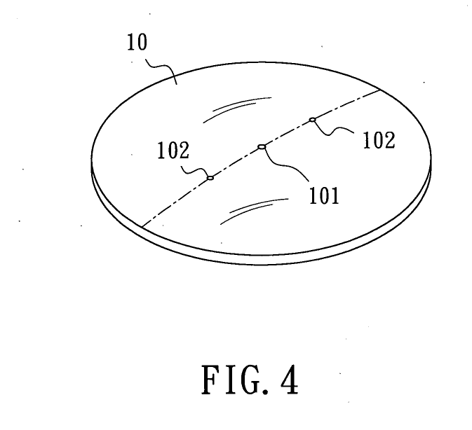

The adhesive label 1 is used for marking machining positions on an eyeglass lens 10 (see FIG. 4), in a manner that will be described in greater detail hereinafter.

It is noted that the eyeglass lens 10 has marks 101, 102 at optical and curvature centers thereof that lie in a principal axis thereof.

The transparent sheet 2 is adapted to be attached adhesively to the eyeglass lens 10, and has opposite first and second surfaces 21, 22.

In this embodiment, the grid pattern 26 is printed, by a printing machine (not shown) , on the second surface 22 of the transparent sheet 2, and has a grid center 23, a horizontal grid line 24 that passes through the grid center 23, a vertical grid line 25 that passes through the grid center 23 and that is transverse to the horizontal grid line 24, and a grid 27 that has a plurality of solid horizontal lines that are parallel to the horizontal grid line 24, and a plurality of solid vertical lines that are parallel to the vertical grid line 25. The grid pattern 26 facilitates accurate markings of the machining positions on the eyeglass lens 10.

It is noted that the horizontal and vertical lines of the grid 27 of the grid pattern 26 may have different thicknesses or colors for easy identification.

The first adhesive layer 3 is applied to the first surface 21 of the transparent sheet 2.

The first release sheet 4 is adhesively attached to the first adhesive layer 3, and covers the first surface of the transparent sheet 2, thereby permitting the adhesive label 1 to be transported conveniently.

The second release sheet 6 is transparent, and covers the second surface 22 of the transparent sheet 2 for protecting the grid pattern 26.

The second adhesive layer 5 is applied to the second release sheet 6, and is adhesively attached to the second surface 22 of the transparent sheet 2 when the second release sheet 6 covers the second surface 22 of the transparent sheet 2.

It is noted that the first adhesive layer 3 has an adhesiveness which is greater than that of the second adhesive layer 5.

In this embodiment, the first and second release sheets 4, 6 have first end portions 41, 61 that are connected to each other. The construction as such permits sequential removal of the first and second release sheets 4, 6 from the transparent sheet 2.

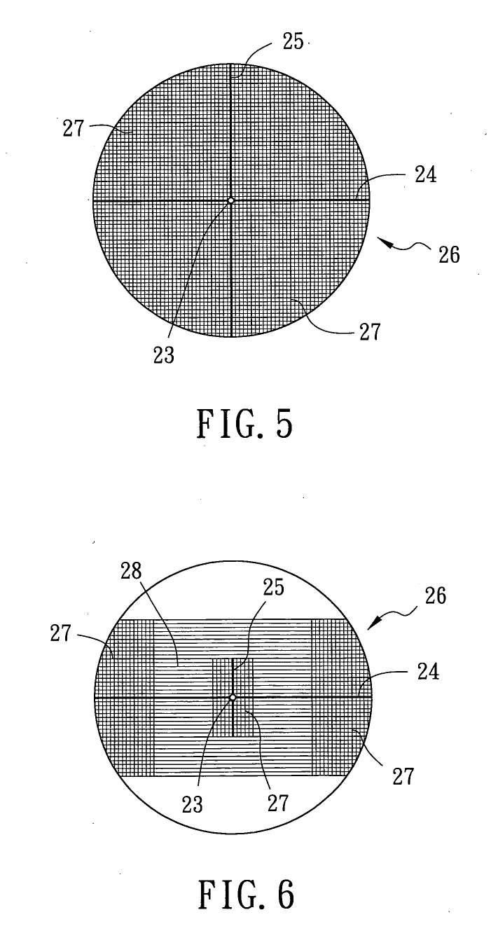

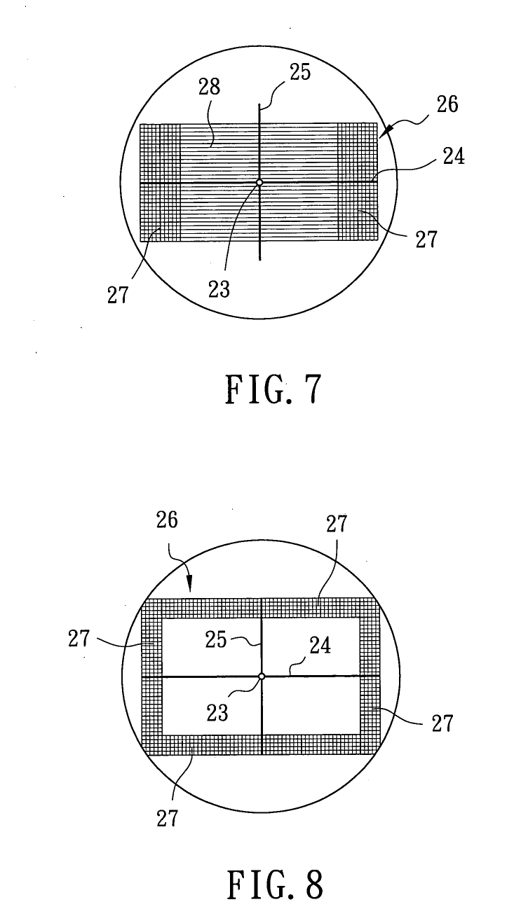

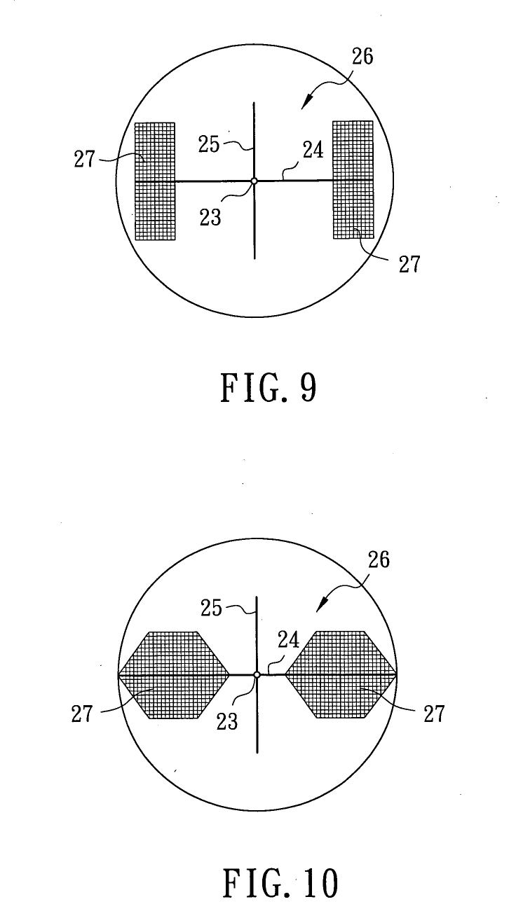

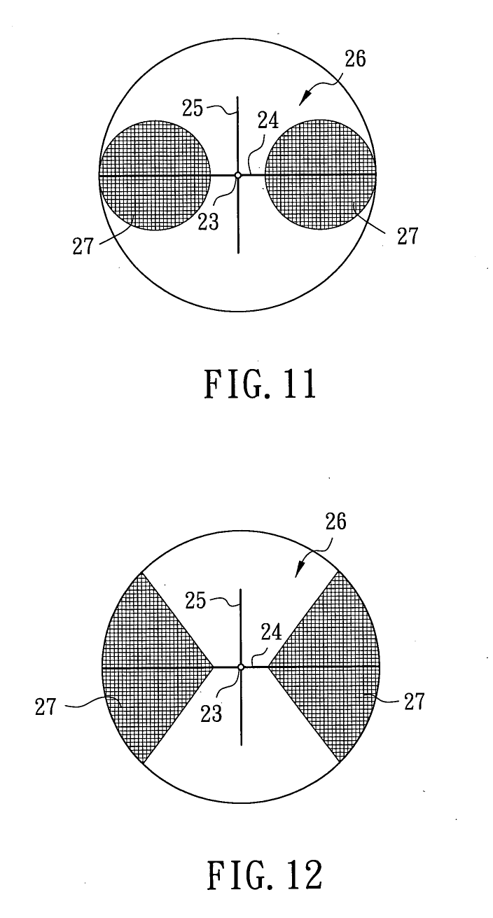

The grid pattern 26 may be of different shapes and sizes. As illustrated in FIG. 5, the grid pattern 26 includes a pair of the grids 27 that are disposed at the opposite sides of the horizontal grid line 24. As illustrated in FIG. 6, the grid pattern 26 includes three of the grids 27, namely first, second and third grids 27, and a plurality of horizontal lines 28. The first and second grids 27 are disposed respectively at the opposite sides of the vertical grid line 25. The horizontal lines 28 extend between the grids 27. The third grid 27 is disposed between the first and second grids 27. As illustrated in FIG. 7, the grid pattern 26 includes a pair of the grids 27 that are rectangular in shape and that are disposed respectively at the opposite sides of the vertical grid line 25, and the horizontal lines 28 that extend between the grids 27. As illustrated in FIG. 8, the grid pattern 26 includes four of the grids 27. Two of the grids 27 are spaced apart from each other and are disposed respectively at the opposite sides of the vertical grid line 25. The other two of the grids 27 are spaced apart from each other and are disposed respectively at the opposite sides of the horizontal grid line 24. As illustrated in FIG. 9, the grid pattern 26 includes two of the grids 27 that are rectangular in shape, that are spaced apart from each other, and that are disposed respectively at the opposite sides of the vertical grid line 25. As illustrated in FIG. 10, the grid pattern 26 includes two of the grids 28 that are hexagonal in shape, that are spaced apart from each other, and that are disposed respectively at the opposite sides of the vertical grid line 25. As illustrated in FIG. 11, the grid pattern 26 includes two of the grids 27 that are circular in shape, that are spaced apart from each other, and that are disposed respectively at the opposite sides of the vertical grid line 25. As illustrated in FIG. 12, the grid pattern 26 includes two of the grids 27 that are sector-shaped, that are spaced apart from each other, and that are disposed respectively at the opposite sides of the vertical grid line 25.

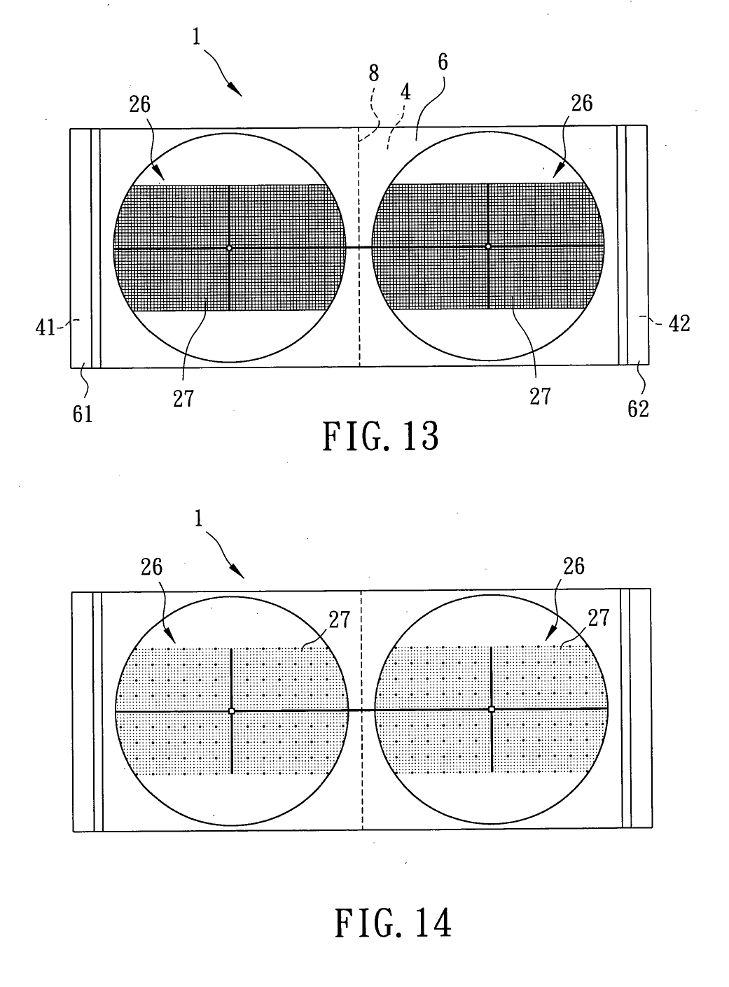

FIG. 13 illustrates the second preferred embodiment of an adhesive label 1 according to this invention. When compared to the previous embodiment, the adhesive label 1 includes two of the grid patterns 26 that are spaced apart from each other. The construction as such permits the transparent sheet 2 of the adhesive label 1 to be simultaneously attached to a pair of the eyeglass lens 10 (only one is shown in FIG. 4). Moreover, the adhesive label 1 further includes a cutting line 8 provided between the grid patterns 26. Further, the first and second release sheets 4, 6 have second end portions 42, 62 that are opposite to the first end portions 41, 61 thereof, respectively, and that are connected to each other. In this embodiment, the grid 27 of each of the grid patterns 26 includes a plurality of solid horizontal lines and a plurality of solid vertical lines.

FIG. 14 illustrates the third preferred embodiment of an adhesive label 1 according to this invention. When compared to the second preferred embodiment, the grid 27 of each of the grid patterns 26 includes a plurality of dotted horizontal lines and a plurality of dotted vertical lines.

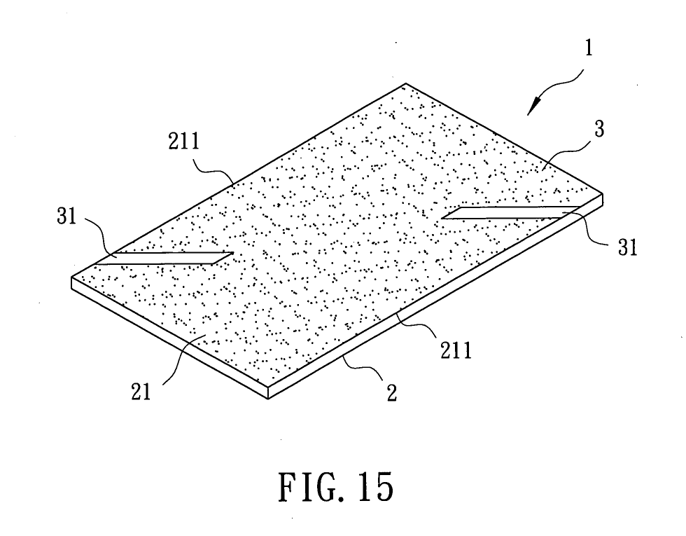

FIG. 15 illustrates the fourth preferred embodiment of an adhesive label 1 according to this invention. When compared to the previous embodiments, the first surface 21 of the transparent sheet 2 has first and second adhesive-free areas 31 that are parallel to each other, that are free of the first adhesive layer 3, and that extend from opposite edges 211 of the first surface 21 of the transparent sheet 2 toward a center of the first surface 21 of the transparent sheet 2. The construction as such facilitates the peeling of the transparent sheet 2 off from the eyeglass lens 10.

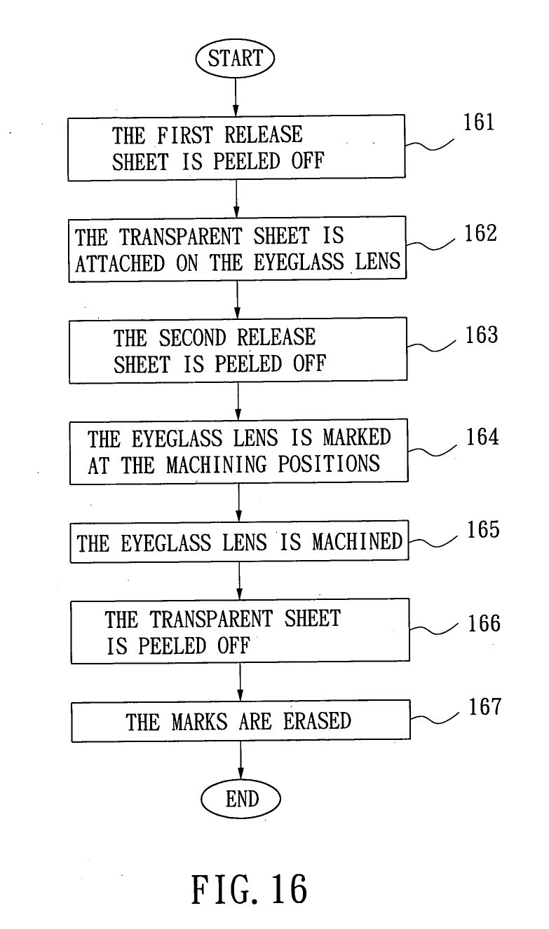

The first preferred embodiment of a method for machining the eyeglass lens 10, which has the marks 101, 102 at the optical and curvature centers thereof (see FIG. 4), with the use of the adhesive label 1 according to this invention will now be described with further reference to FIG. 16.

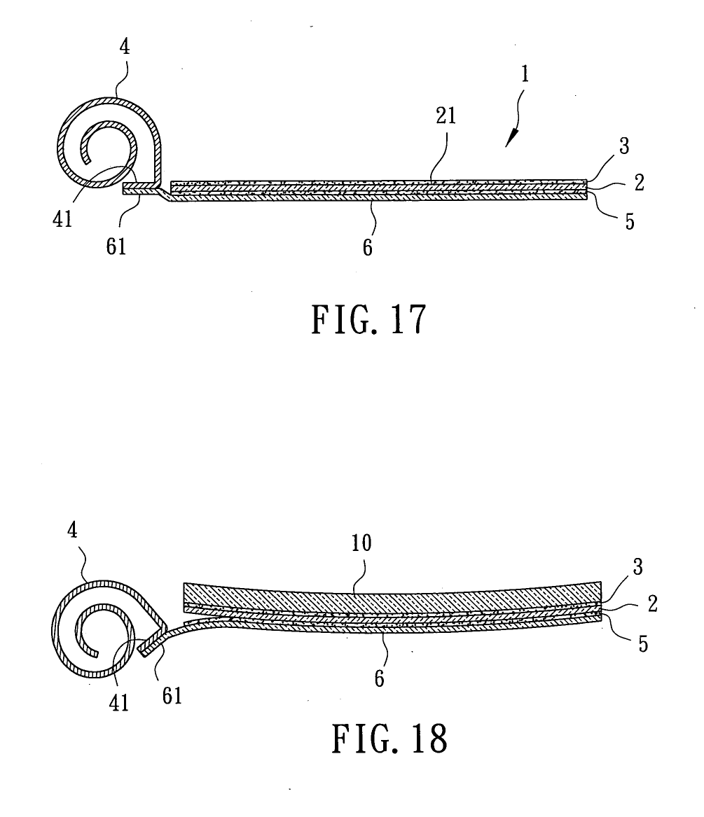

In step 161, as illustrated in FIG. 17, the first release sheet 4 of the adhesive label 1 is peeled off from the first surface 21 of the transparent sheet 2.

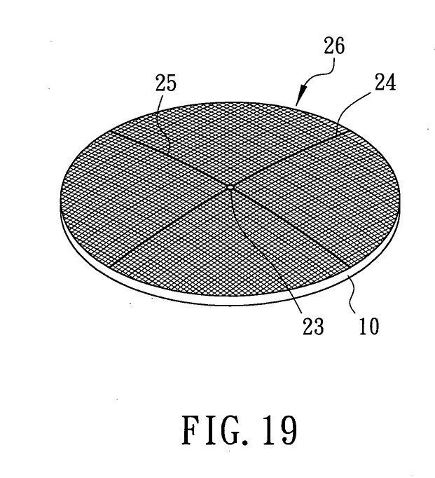

In step 162, as illustrated in FIG. 18, the first surface 21 of the transparent sheet 2 is attached to the eyeglass lens 10 such that the grid center 23 of the grid pattern 26 is aligned with the mark 101 at the optical center of the eyeglass lens 10, and such that the horizontal grid line 24 of the grid pattern 26, which passes through the grid center 23 of the grid pattern 26, passes through the marks 102 at the curvature centers of the eyeglass lens 10, as best shown in FIG. 19.

In step 163, the second release sheet 6 of the adhesive label 1 is peeled off from the second surface 22 of the transparent sheet 2.

In step 164, the eyeglass lens 10 is marked at the machining positions with reference to the grid pattern 26.

In step 165, the eyeglass lens 10 is machined at the machining positions marked in step 164.

In step 166, the transparent sheet 2 of the adhesive label 1 is peeled off from the eyeglass lens 10.

In step 167, the marks 101, 102 at the optical and curvature centers of the eyeglass lens 10 are erased.

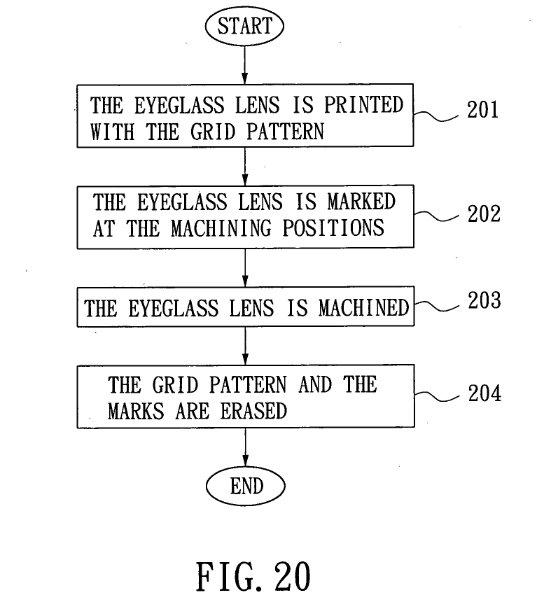

The second preferred embodiment of a method for machining the eyeglass lens 10, which has the marks 101, 102 at the optical and curvature centers thereof, according to this invention will now be described with further reference to FIG. 20.

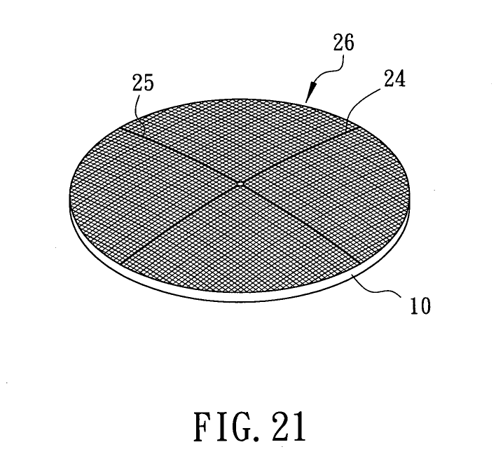

In step 201, the eyeglass lens 10 is printed with the grid pattern 26 such that the grid center 23 thereof is aligned with the mark 101 at the optical center of the eyeglass lens 10, and such that the horizontal grid line 24 thereof passes through the grid center 23 and the marks 102 at the curvature centers of the eyeglass lens 10, as best shown in FIG. 21.

In step 202, the eyeglass lens 10 is marked at the machining positions with reference to the grid pattern 26.

In step 203, the eyeglass lens 10 is machined at the machining positions marked in step 202.

In step 204, the grid pattern 26 and the marks 101, 102 at the optical and curvature centers of the eyeglass lens 10 are erased.

From the above description, the present invention has the following advantages.

1. The methods permit machining, such as fine grinding, cutting, boring, polishing, or engraving, of the eyeglass lens 10 both accurately and with good reproducibility.

2. The methods are easy to perform, and shorten machining operation time and minimize machining errors of the eyeglass lens 10, thereby reducing production cost.

3. Not only is the adhesive label 1 inexpensive to produce, the use of conventional machining apparatus (not shown) is also permitted such that no large investment in equipment is needed.

4. When the transparent sheet 2 of the adhesive label 1 is attached to the eyeglass lens 10, the transparent sheet 2 protects the eyeglass lens 10 from abrasion during polishing operation.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for machining an eyeglass lens having marks at optical and curvature centers thereof, said method comprising the step of:
printing the eyeglass lens with a grid pattern having a grid center that is aligned with the mark at the optical center of the eyeglass lens, and a grid line that passes through the grid center and the mark at the curvature center of the eyeglass lens so as to facilitate accurate markings of machining positions on the eyeglass lens to be machined.

2. A method for machining an eyeglass lens having marks at optical and curvature centers thereof, said method comprising the step of:
attaching a transparent sheet, which is printed with a grid pattern having a grid center and a grid line that passes through the grid center, on the eyeglass lens such that the grid center is aligned with the mark at the optical center of the eyeglass lens and such that the grid line of the grid pattern passes through the mark at the curvature center of the eyeglass lens so as to facilitate accurate markings of machining positions on the eyeglass lens to be machined.

3. The method as claimed in claim 2, further comprising the step of peeling the transparent sheet off the eyeglass lens after machining the eyeglass lens.

4. A lens unit, comprising:
an eyeglass lens having marks at optical and curvature centers thereof; and
a grid pattern provided on said eyeglass lens, said grid pattern having a grid center aligned with the mark at the optical center of said eyeglass lens, and a grid line passing through the grid center and the mark at the curvature center of said eyeglass lens.

5. The lens unit as claimed in claim 4, wherein said grid pattern is printed on said eyeglass lens.

6. The lens unit as claimed in claim 4, wherein said grid pattern is printed on a transparent sheet that is attached to said eyeglass lens.

7. An adhesive label, comprising:
a transparent sheet adapted to be attached adhesively to an eyeglass lens that has marks at optical and curvature centers thereof; and
a grid pattern printed on said transparent sheet, and having a grid center that is adapted to be aligned with the mark at the optical center of the eyeglass lens, and a grid line that passes through the grid center and that is adapted to pass through the mark at the curvature center of the eyeglass lens.

8. The adhesive label as claimed in claim 7, wherein said transparent sheet has opposite first and second surfaces, said adhesive label further comprising a first adhesive layer applied to at least a portion of said first surface of said transparent sheet, said grid pattern being printed on said second surface of said transparent sheet.

9. The adhesive label as claimed in claim 8, further comprising:
a first release sheet covering said first surface of said transparent sheet and adhesively attached to said first adhesive layer.

10. The adhesive label as claimed in claim 9, further comprising a second release sheet that is transparent and that covers said second surface of said transparent sheet, and a second adhesive layer that is applied to said second release sheet and that is adhesively attached to said second surface of said transparent sheet.

11. The adhesive label as claimed in claim 10, wherein said first and second release sheets have end portions that are attached adhesively to each other.

12. The adhesive label as claimed in claim 10, wherein said first adhesive layer has an adhesiveness which is greater than that of said second adhesive layer.

13. The adhesive label as claimed in claim 8, wherein said first surface of said transparent sheet has an adhesive-free area that is free of said first adhesive layer.

14. The adhesive label as claimed in claim 13, wherein said first surface of said transparent sheet further has an edge, said adhesive-free area of said first surface of said transparent sheet extending from said edge of said first surface of said transparent sheet.
